(19) United States
(12) Patent Application Publication
(10) Pub. No.: US 2015/0350553 A1
(43) Pub. Date: Dec. 3, 2015

(54) SYSTEMS AND METHODS FOR MENU DIRECTED INSPECTION

(71) Applicant: General Electric Company, Schenectady, NY (US)

(72) Inventors: Ritwick Jana, Bangalore (IN); Bryan David Maule, Skaneateles Falls, NY (US); Michael Christopher Domke, Skaneateles Falls, NY (US)

(21) Appl. No.: 14/292,840

(22) Filed: May 31, 2014

(51) Int. Cl. H04N 5/232; H04N 7/18

(52) U.S. Cl. CPC H04N 5/23293; H04N 7/183; H04N 2005/2255

(57) ABSTRACT

A non-destructive testing (NDT) device includes a processor operatively coupled to a camera and to a display. The processor is configured to navigate a graphical tree model of an inspection. The graphical tree model includes a plurality of nodes that each correspond to an inspection point of the inspection. The processor is also configured to display at least one of the plurality of nodes; the display of a node includes an icon indicative of the presence of a flagged image, a flagged video, or a combination thereof associated with the node. Further, the processor is configured to receive a user selection of the at least one of the plurality of nodes, receive a user input to acquire an image or video, associate the image or video with the selected one of the plurality of nodes, and update the display of the selected one of the plurality of nodes.

### BACKGROUND

The subject matter disclosed herein relates to non-destructive inspection. Specifically, the subject matter described below relates to systems and methods for performing non-destructive testing via menu directed inspection (MDI).

Certain devices may be used to inspect a variety of systems and facilities, such as power generation equipment and facilities, oil and gas equipment and facilities, aircraft equipment and facilities, manufacturing equipment and facilities, and the like. The inspection equipment may include various non-destructive inspection or non-destructive testing (NDT) devices. For example, video borescopes, portable eddy current inspection devices, portable X-ray inspection devices, and the like, may be used to observe or otherwise inspect the system and facilities using non-destructive inspection techniques. The NDT devices may include graphical user interfaces useful in enabling users to perform various monitoring functions. It would be beneficial to improve the graphical user interfaces for NDT inspection.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a non-destructive testing (NDT) device includes a processor operatively coupled to a camera and to a display. The processor is configured to navigate a graphical tree model of an inspection. The graphical tree model includes a plurality of nodes that each correspond to an inspection point of the inspection. The processor is also configured to display at least one of the plurality of nodes; the display of a node includes an icon indicative of the presence of a flagged image, a flagged video, or a combination thereof associated with the node. Further, the processor is configured to receive a user selection of at least one of the plurality of nodes, receive a user input to acquire an image or video, associate the image or video with the selected one of the plurality of nodes, and update the display of the selected one of the plurality of nodes.

In a second embodiment, a non-transitory tangible computer-readable medium includes executable code having instructions. The instructions are configured to navigate a tree model of an inspection. The tree model includes a plurality of nodes that each correspond to an inspection point of the inspection. The instructions are also configured to display each of the plurality of nodes; the display of a node includes an icon indicative of the presence of a flagged image, a flagged video, or a combination thereof associated with the node. Further, the instructions are configured to receive a user selection of one of the plurality of nodes, receive a first user input to acquire an image or video, associate the image or video with the selected one of the plurality of nodes, update the display of the selected one of the plurality of nodes, and generate a document that includes the images associated with the plurality of nodes. The non-transitory computer-readable medium is part of a non-destructive testing (NDT) device having a processor configured to execute the executable code.

In a third embodiment, a method of performing non-destructive testing (NDT) includes navigating a tree model of an inspection. The tree model has a plurality of nodes that each correspond to an inspection point of the inspection. The method also includes displaying each of the plurality of nodes; displaying a node includes displaying an icon indicative of the presence of a flagged image, a flagged video, or a combination thereof associated with the node. Further, the method includes receiving a user selection of one of the plurality of nodes, receiving a user input to acquire an image or video, associating the image or video with the selected one of the plurality of nodes, and updating the display of the selected one of the plurality of nodes.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a plurality of non-destructive testing (NDT) devices and systems, in accordance with an embodiment of the present approach;

FIG. 2 is a screenshot of a home screen included in a graphical user interface (GUI) of an NDT device of FIG. 1, in accordance with an embodiment of the present approach;

FIG. 3 is a screenshot of an inspection details screen included in the GUI of the NDT device of FIG. 1, in accordance with an embodiment of the present approach;

FIG. 4 is a screenshot of an inspection point screen included in the GUI of the NDT device of FIG. 1, in accordance with an embodiment of the present approach;

FIG. 5 illustrates various screens embodiments displayed by navigating through an inspection point tree, in accordance with an embodiment of the present approach;

FIG. 6 is a screenshot of an inspection point screen included in the GUI of the NDT device of FIG. 1, in accordance with another embodiment of the present approach;

FIG. 7 is a screenshot of a report settings screen included in the GUI of the NDT device of FIG. 1, in accordance with an embodiment of the present approach; and

FIG. 8 is a screenshot of a page layout screen included in the GUI of the NDT device of FIG. 1, in accordance with an embodiment of the present approach.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Present embodiments are generally directed towards systems for performing non-destructive inspections of industrial equipment, using, for example, a variety of portable non-destructive testing (NDT) devices described in more detail below. Specifically, the embodiments described herein relate to a graphical user interface (GUI) providing for a menu-driven inspection (MDI) technique. An MDI structure may model the inspection areas and points as an inspection point tree. An NDT device operator may then navigate through the inspection point tree to acquire images and videos of the specified inspection areas and points. By following the inspection point tree, the operator may quickly and efficiently inspect the equipment and obtain improved testing coverage of the equipment. Further, the MDI structure may automatically associate the acquired images and videos with the corresponding inspection areas and points, which may improve equipment and facilities inspection, for example, when compared to not using the MDI techniques disclosed herein. The MDI GUI may also allow the operator to flag an image or video if he or she suspects or observes a defect within a particular inspection point or area. The GUI may then presents in tandem an icon that indicates if any images and videos for an inspection point or area are flagged. Additionally, the GUI may include an interactive marker that displays the current path traversed through the inspection point tree and may be used to navigate to different nodes of the inspection point tree.

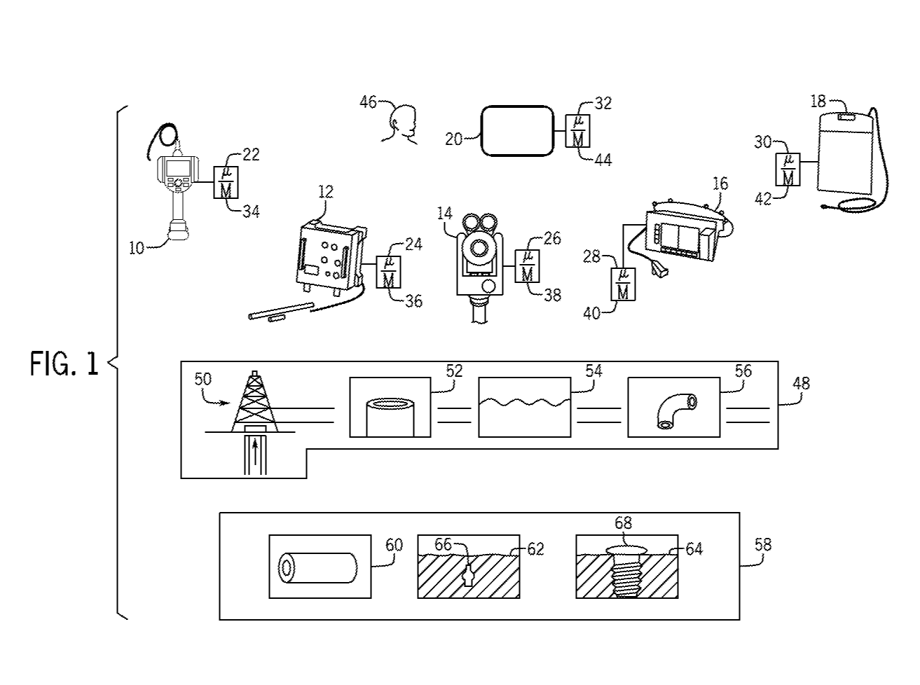

By way of introduction, FIG. 1 depicts a block diagram of embodiments of a variety of portable NDT systems that may include the techniques described herein. In the depicted embodiment, the portable NDT systems may include a video borescope 10, an eddy current inspection device 12, a transportable pan-tilt-zoom (PTZ) camera 14, an ultrasonic flaw detector 16, a portable digital radiography device 18, and an interface device 20. The interface device 20 may be a mobile device (e.g., cell phone, laptop, tablet, etc.) communicatively coupled to the aforementioned NDT systems 10, 12, 14, 16, and 18 suitable for providing enhanced visualization (e.g., at a larger screen display), and for remote control and operations of the NDT systems 10, 12, 14, 16, and 18. The NDT systems 10, 12, 14, 16, 18, and 20 may be connected to each other and to local servers (e.g., local area network [LAN] servers), remote servers (e.g., wide area network [WAN] servers), and “cloud” based devices and services. In one embodiment, the interface device 20 may be a MENTOR™ hardware device or software “app” executable via a mobile device (e.g., cell phone, phone, tablet, etc.) available from General Electric Company, of Schenectady, N.Y. Likewise, the devices 10, 12, 14, 16, and 18 may also be available from General Electric Company, of Schenectady, N.Y.

The depicted NDT devices 10, 12, 14, 16, 18, and 20 include respective processors 22, 24, 26, 28, 30, and 32 and memory 34, 36, 38, 40, 42, and 44. The NDT devices 10, 12, 14, 16, 18, and 20 may additionally include a communications system suitable for communicating with other NDT devices 10, 12, 14, 16, 18, and 20 and with external systems such as “cloud” based systems, servers, computing devices (e.g., tablets, workstations, laptops, notebooks, etc.) and the like. The memory 34, 36, 38, 40, 42, and 44 may include tangible non-transitory storage suitable for storing computer code or instructions implementing the various techniques described herein and executable via the respective processors 24, 26, 28, 30, 32, and 34. The devices 10, 12, 14, 16, 18, and 20 may also include respective displays useful in visualizing the techniques described herein. In operation, an operator 46 may utilize the NDT system 10, 12, 14, 16, 18, and 20 to inspect facilities 48, including facilities that may have oil and gas equipment 50, and may include locations such as the interior of pipes or conduits 52, underwater (or underfluid) locations 54, and difficult to observe locations such as pipes or conduits having curves or bends 56. Other systems 58 may also be inspected, such as aircraft systems, power generation systems (e.g., gas turbines, steam turbines, wind turbines, hydroturbines, combustion engines, generators, electric motors, etc.), machinery (e.g., compressors, expanders, valves, actuators, etc.) and the like, that may include conduits 60, various surfaces 62 and 64, and may be used to find undesired cracks 66 or to visualize parts 68, among many other uses. Accordingly, it may be possible to enhance the visual observation of various equipment, such as an aircraft system 58 and facilities 48, with x-ray observation modalities, ultrasonic observation modalities, and eddy current observation modalities. For example, the interior and the walls of pipes 52, 56, and 60 may be inspected for corrosion and erosion. Likewise, obstructions or undesired growth inside of the pipes 52, 56, and 60 may be detected by using the devices 10, 12, 14, 16, 18, and 20. Similarly, fissures or cracks disposed inside of certain ferrous or non-ferrous material 62 and 64 may be observed. Additionally, the disposition and viability of parts 68 inserted inside of components may be verified. Indeed, using the techniques described herein may improve inspection of the facilities 48 and systems 58.

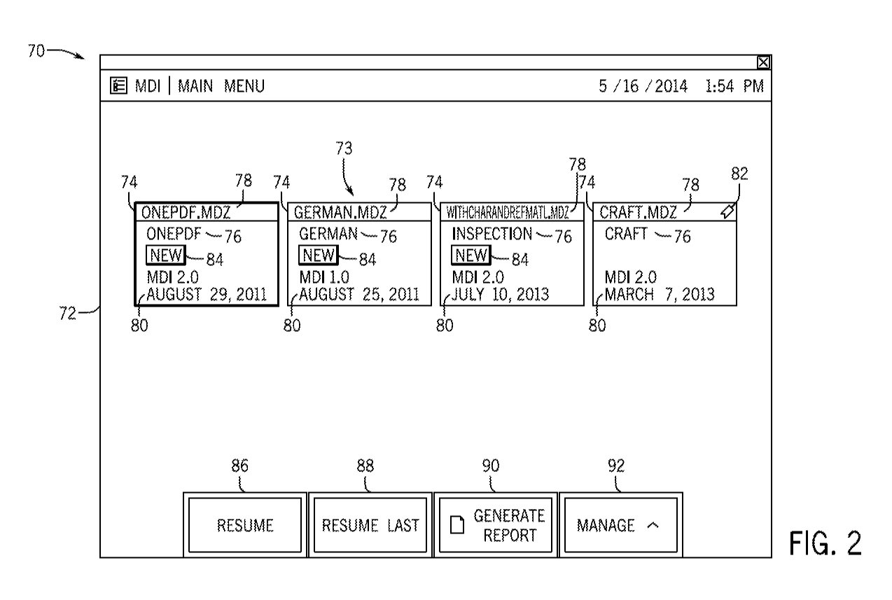

The NDT devices 10, 12, 14, 16, and 18 utilize a menu-driven inspection (MDI) GUI to enable the operator 46 to inspect facilities 48 and systems 58. MDI, as described herein, is a technique for NDT inspection that utilizes graphical “menus” with certain visual components (e.g., icons, textual components, numeric components, and so on) to aid the operator 46 in navigating the device (e.g., NDT devices 10, 12, 14, 16, 18 and 20) to different location within and around the facilities 48 and systems 58 to acquire images and videos. The MDI program on the NDT devices 10, 12, 14, 16, 18, and 20 utilize a GUI 70, as shown in FIGS. 2-8 and described further below. However, the embodiments and features of the embodiments described below may also be applied to other types of inspection programs used with NDT devices.

Turning now to FIG. 2, the GUI 70 includes a home screen 72. The home screen 72 may be the first screen the NDT device (e.g., the video borescope 10) presents upon start-up. Alternatively, the home screen 72 may be presented after other screens. The home screen 72 includes a list 73 of all of the ongoing inspections assigned to the operator 46. Each ongoing inspection is represented by a tile 74. It should be noted that, in other embodiments of the interface structure 70, other types of design schemes may be used to depict ongoing inspections. In the depicted embodiment, the list 73 includes four tiles 74.

Each tile 74 may include a label or title 76 used to identify the inspection, the name 78 of a folder containing the data related to the inspection, and a date 80 corresponding to the last date on which the inspection was performed, as shown in FIG. 2. In some embodiments, a particular tile 74 may also include a flag icon 82 suitable for “bookmarking” or otherwise indicating that the corresponding inspection is the last performed inspection. Further, in some embodiments, the tiles 74 may include a “new” label 84 that signifies that the corresponding inspection was downloaded to the NDT device during the last period in which the NDT device connected to an external system used for creating, assigning, and overseeing inspections. Alternately or additionally, the “new” label 84 may signify that the operator 46 has yet to begin the corresponding inspection. That is, the “new” label 84 may signify that the tile 74 corresponds to a template for the corresponding inspection, and that the operator 46 has yet to begin or complete the corresponding inspection.

The home screen 72 may also include several buttons (e.g., virtual buttons) representing actions that the operator 46 may take with regards to the inspections, as depicted in FIG. 2. For instance, the operator 46 may select any of the tiles 74 and then activate a “resume” button 86 to resume the corresponding inspection. Activating the “resume” button 86 may bring the operator 46 to the last saved spot in the inspection or to the beginning of the inspection. In another example, the operator 46 may activate a “resume last” button 88, which will resume the last performed inspection. This selection may bring the operator 46 to the last saved spot in the inspection or to the beginning of the inspections, similarly to the “resume” button 86.

The operator 46 may also select any of the tiles 74 and then activate a “generate report” button 90 that creates a shell document for a report that includes the images associated with the corresponding inspection. The “generate report” button 90 and its associated features are described in more detail below. Further, the operator may select any of the tiles 74 and activate a “manage” menu 92 to access options related to managing the corresponding inspection.

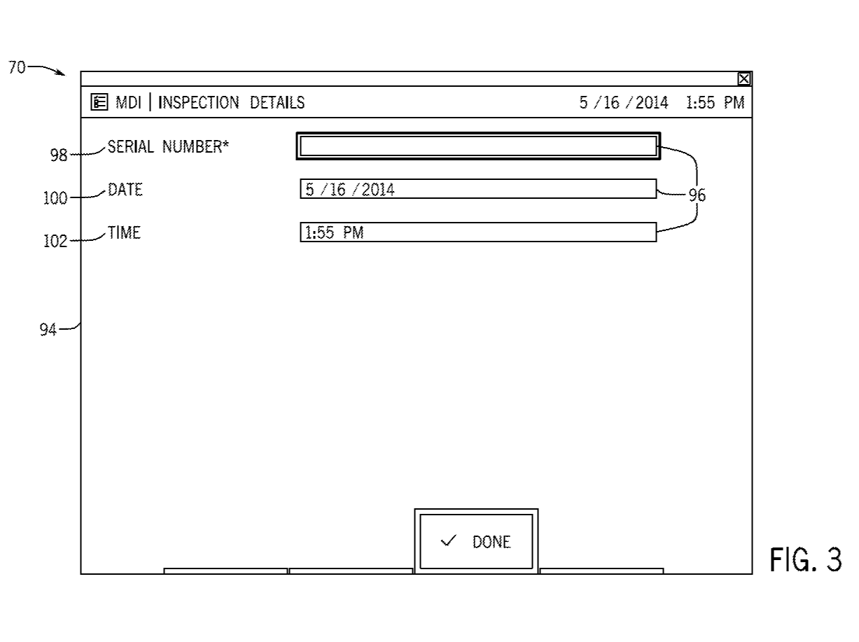

When the operator 46 selects a new inspection, such as the “Craft” inspection depicted in FIG. 2, he or she is then presented with an inspection details screen 94, which is shown in FIG. 3. The inspection details screen 94 may be used to collect and capture information related to the overall inspection. Some of the information may be inputted by the operator 46 into a text box 96, such as the serial number 98 of the equipment to be inspected. Additionally, some of the information, such as the current date 100 and time 102, may be automatically captured and entered into a text box 96.

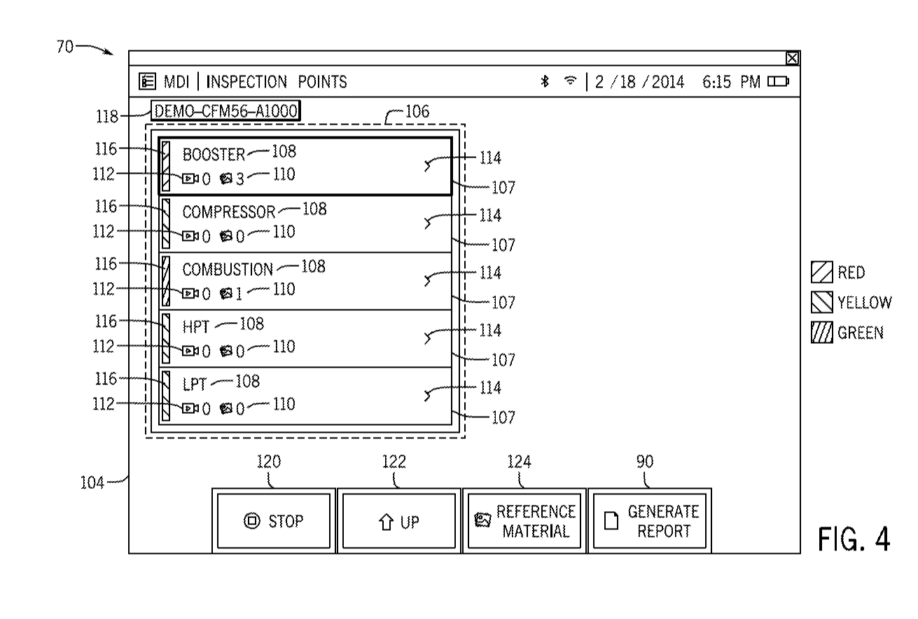

Once the information has been entered into the inspection details screen 94, the operator 46 may then begin the inspection. In one embodiment, the inspection may be modeled by using an inspection point tree data structure, which, as shown in FIGS. 4-6, may then be displayed as a hierarchical view of the inspection points. Specifically, each inspection point and area may be represented as a node of the inspection point tree. As depicted in FIGS. 4-6, each node may have children. For example, a node corresponding to an inspection area may have several children that corresponding to inspection points located within the inspection area.

Turning now to FIG. 4, the operator 46 first views an inspection point screen 104 associated with a root of the inspection point tree 106. Although the inspection point screen 104 is described below in relation to the root of the inspection point tree 106, it should be noted that the inspection point screen 104 may be navigated and used to display any node of the inspection point tree 106.

The inspection point screen 104 may include child nodes 107 of the current node (e.g., the root in the depicted embodiment). For instance, the inspection point screen 104 in FIG. 4 includes five child nodes 107 corresponding to the five children of the root of the inspection point tree 106. Each child node 107 includes a name 108 of the node and the associated inspection point or area, a counter 110 that represents the number of images currently captured for the child node 107, and a counter 112 that represents the number of videos currently captured for the child node 107. If a particular child node 107 has any children, then the child node 107 may include a right-arrow icon 114 that, when selected, will cause the screen 104 to redisplay all children nodes of the selected node 107 (e.g., grandchildren nodes of the root of the tree 106), thus enabling navigation through the tree 106 in a depth-first manner. Other tree navigation techniques, including breadth-first, go-to-node, and so on, may also be used. Each child node 107 also includes a color strip icon 116 that indicates whether any of the images and videos associated with the child node 107 is flagged; the color strip icon 116 is discussed in further detail below.

The inspection point screen 104 may also include an interactive label or marker 118 that shows the current path traversed through the inspection point tree 106. For example, since FIG. 4 depicts the root of the inspection point tree 106, the interactive marker 118 only includes the title of the inspection. As the operator 46 navigates through the inspection point tree 106, the interactive marker 118 expands or collapses to show the current path. Further, each node displayed in the interactive marker 118, when selected, will navigate to an inspection point screen 104 for that particular node, such that the operator can navigate through the inspection point tree using the interactive marker 118.

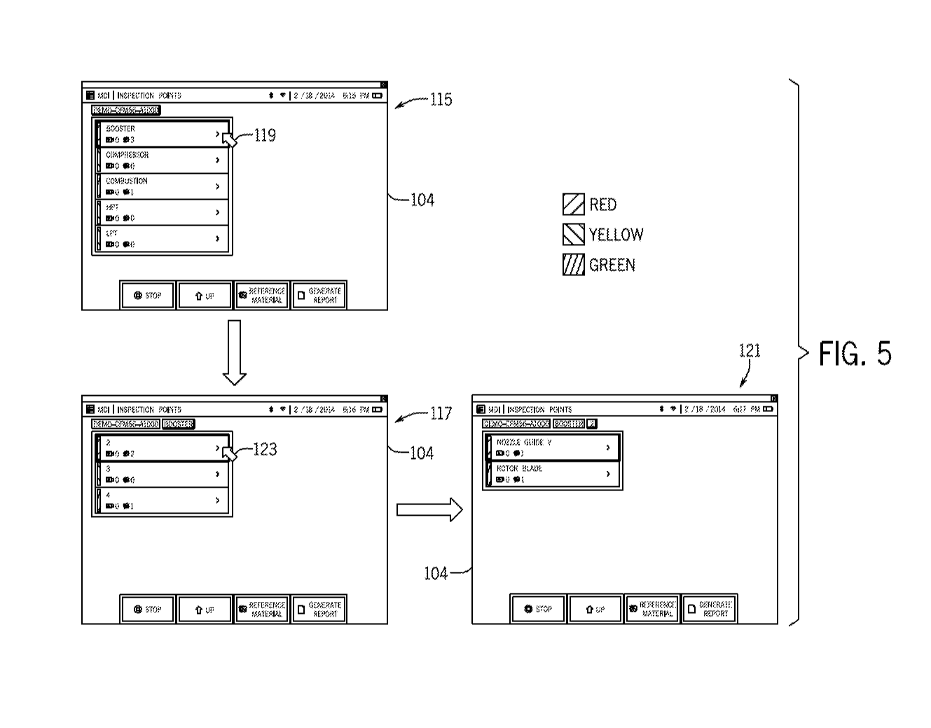

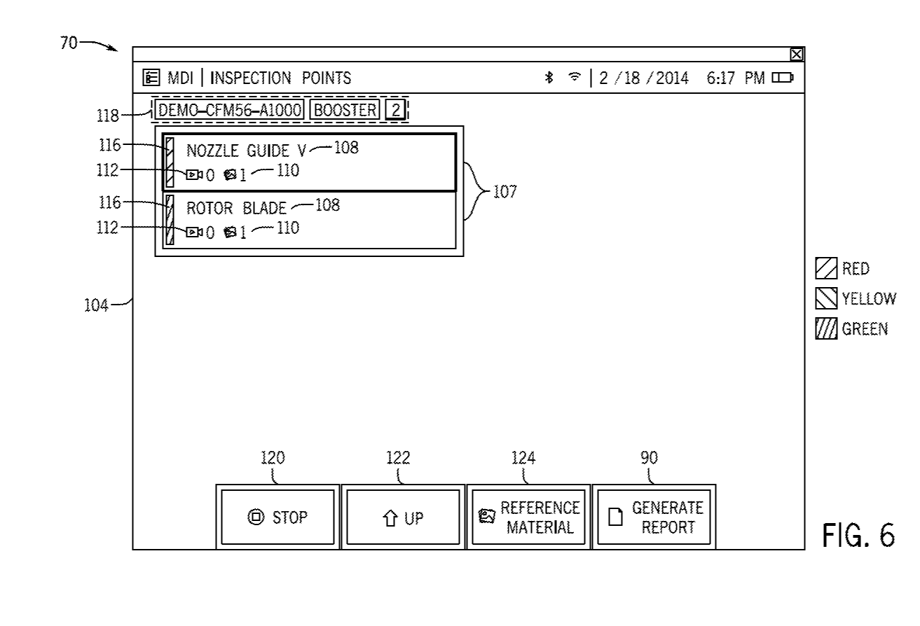

The inspection point screen 104 may further include a “stop” button 120 that, when activated, saves and exits the inspection. For example, the last node navigated through may be saved at a current inspection state. Additionally, the inspection point screen 104 may include an “up” button 122 that, when selected, will navigate to an inspection point screen 104 for the parent node of the current node. As will be appreciated, the “up” button 122 may be an alternative to using the interactive marker 118 to navigate through the inspection point tree. The inspection point screen 104 may also include a “reference material” button 124, that when selected, will prompt a display of reference materials associated with the current node. The “reference material” button 124 is described in further detail below. Finally, the inspection point screen 104 may include a “generate report” button 90. It is to be noted that, in some embodiments, the background of the inspection point screen 104 may be the current view of the sensor (e.g., camera), as shown in FIG. 4. Indeed, the graphical menus of FIG. 4 may be superimposed onto images or video and used during the inspection process. Using the right-angle icons 114, the interactive marker 118, and the “up” buttons 122, the operator 46 may navigate to all nodes of the inspection point tree 106. For example, the operator 46 may navigate through a particular level of the inspection point tree 106, as shown in FIG. 5. For example, FIG. 5 depicts a first screen state 115, then a second screen state 117 arrived at via user selection 119, and then a third screen state 121 arrived at via user selection 123, to arrive at the inspection point screen 104 depicted in FIG. 6.

As described above, the inspection point screen 104 of FIG. 6 includes child nodes 107, the interactive marker 118, the “stop” button 120, the “up” button 122, the “reference material” button 124, and the “generate report” button 90. Further, neither of the two child nodes 107 have children, as evidenced by the lack of right-angle icons 114 in FIG. 6. At this point, the operator 46 can acquire images or videos for each of the inspection points represented by the child nodes 107 (i.e., Nozzle Guide V and Rotor Blade). In particular, the operator 46 selects one of the child nodes 107 and then begins to acquire images and videos. The MDI program associates the acquired images and videos with the selected child node 107 as the images and videos are captured, thereby improving over a manual association process (e.g., non MDI process) performed after completion of the inspection. Further, as the operator 46 acquires images and videos, the counters 110 and 112 update on the display operatively coupled to the NDT device. As will be appreciated, the counters 110 and 112 for the parent node, grandparent nodes, and the like also update, albeit off-screen.

If the operator 46 suspects or observes a defect (e.g., a crack 66) based on an image or video, he or she can flag the image or video. As mentioned above, the color strip icon 116 updates as necessary to indicate if an image or video associated with an inspection point node is flagged. For example, in FIG. 6, the child node 106 titled “Nozzle Guide V” has a red color strip icon 116, which signifies that at least one image or video associated with the inspection point node is flagged. However, the child node “106” titled “Rotor Blade” has a green color strip icon 116, which signifies that none of the associated images and videos is flagged. In some embodiments, the functionality of the color strip icon 116 may be combined with the functionality of the counters 110 and 112. For instance, a yellow color strip icon 116 may signify that no images or videos have been acquired for the selected inspection point node and its children. It should be noted that, similarly to the counters 110 and 112, flagging images and videos affects the color strip icon 116 not only for the selected child node 106 but for the parent node, grandparent nodes, and the like.

In addition to flagging images and videos, the operator 46 may also add comments. Some common comments, such as “conduit needs to be flushed” may be pre-saved options that the operator 46 can select to add to an image or video. Further, in certain embodiments, the operator 46 may also record voice annotations during the inspection of a particular child node 107.

As mentioned above, the inspection point screen 104 depicted in FIG. 6 includes the “reference material” button 124. When selected, the “reference material” button 124 prompts a display of reference manuals relevant to the selected inspection point node. The reference manuals can illustrate a range of states for the corresponding inspection point (e.g., “excellent condition,” “acceptable,” “needs maintenance,” etc.) that the operator 46 may compare to acquired images and videos to evaluate the inspection point. In some embodiments, the reference manuals may be shown side-by-side with the MDI program such that the operator 46 may view the MDI program and the reference manuals without navigating between the two objects.

The inspection point screen 104 of FIG. 6 also includes the “generate report” button 90, as stated above. When activated, the “generate report” button 90 generates a shell document for a report that includes the information collected via the inspection details screen 94 and all of the images and any accompanying data (e.g., if an image is flagged or has any comments). In some embodiments, the shell document also includes a link (e.g., hyperlink) to a repository that includes the videos and any accompanying data. Alternately or additionally, the shell document may include the actual videos and any accompanying data. Similarly, the shell document may include the recorded voice annotations or a link to a repository containing the recorded voice annotations.

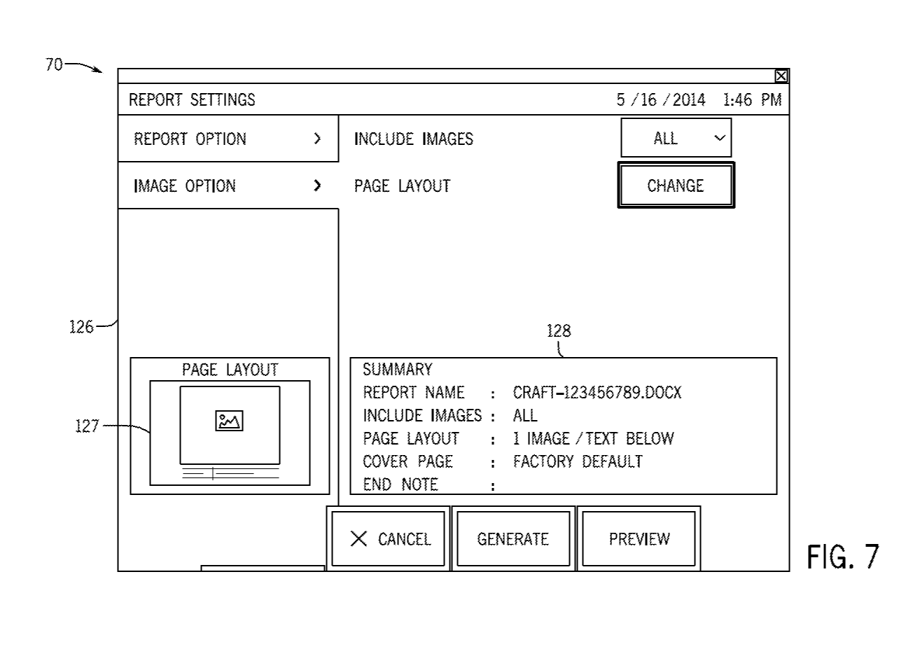

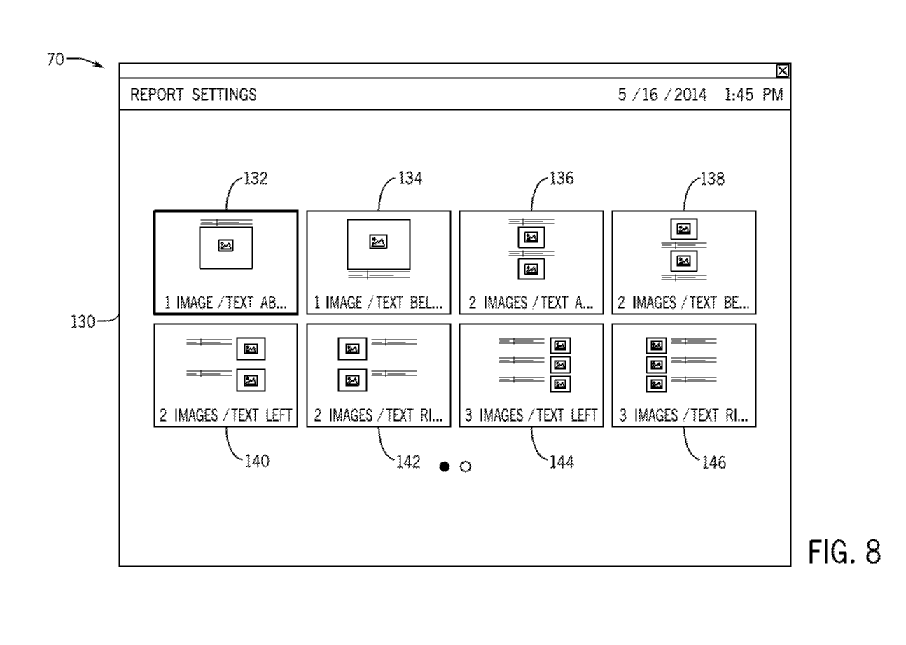

The operator 46 may have some control over the format of the shell document. For instance, selecting the “generate report” button 90 may prompt a report settings screen 126 similar to the one in FIG. 7. The report settings screen 126 may include a summary 128 of the images included in the shell document, the name of the shell document, a layout 127 of the shell document, the type of cover page, and the type of end page. The report settings screen 126 may also include an option for the operator 46 to preview the shell document. If the operator 46 desires, he or she may change any of the information in the summary 128, such as the layout of the shell document. For example, activating the change button as shown in FIG. 7 may prompt a page layout screen 130, as depicted in FIG. 8, which lists a variety of formatting or layout embodiments for the shell document. For example, a single image with text on the top layout 132, a single image with text on the bottom layout 134, a double image with text on top layout 136, a double image with text on the bottom layout 138, double image with text on a left side layout 140, a double image with text on a right layout 142, a multiple images with text on a left layout 144, a multiple image with text on the right layout 146, and so on. Indeed, a variety of layouts may be provided, suitable for a number of images with associated text on the top, bottom, left, right, or a combination thereof. Alternately or additionally, some of the information in the summary 128 may be immutable.

Referring back to FIG. 7, once the operator 46 is satisfied with the preview of the shell document, he or she may generate the shell document, which is then saved to the same location as the other files associated with the inspection. In some embodiments, the operator 46 may send the generated report, the inspection file, images, videos, and other associated data to a repository, the inspection system mentioned above, and other components, devices, and systems.

Technical effects of the present embodiments include systems for performing remote visual inspection of industrial equipment. Certain embodiments may increase the efficiency and efficacy of inspections. For example, the present embodiments include an GUI for an MDI process that guides users through inspection areas and points based on an inspection point tree. For example, an operator may traverse the tree to acquire images and videos of the specified inspection areas and points. By following the inspection point tree, the operator may quickly and efficiently inspect the equipment while still obtaining sufficient coverage of the equipment. Further, the present GUI may automatically associate the acquired images and videos with the corresponding inspection areas and points, which improves on a manual process of associating images and videos with inspection areas and points. It should be noted that the embodiments described in the specification may have other technical effects and can solve other technical problems.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A non-destructive testing (NDT) device, comprising:
a processor operatively coupled to a camera and to a display, wherein the processor is configured to:
navigate a graphical tree model of an inspection, wherein the graphical tree model comprises a plurality of nodes and each of the plurality of nodes corresponds to an inspection point of the inspection;
display at least one of the plurality of nodes, wherein the display of a node comprises
an icon indicative of the presence of a flagged image, a flagged video, or a combination thereof associated with the node;
receive a user selection of the at least one of the plurality of nodes;
receive a user input to acquire an image or video;
associate the image or video with the selected one of the plurality of nodes; and
update the display of the selected one of the plurality of nodes.

2. The NDT device of claim 1, wherein the processor is configured to:
display an interactive marker comprising a current path through the tree model, wherein the current path comprises a list of nodes;
receive a second user selection of a node within the interactive marker; and
display the selected node.

3. The NDT device of claim 1, wherein the processor is configured to receive a second user input to generate a document comprising the image associated with the plurality of nodes.

4. The NDT device of claim 3, wherein the document comprises the video associated with the plurality of nodes.

5. The NDT device of claim 3, wherein the document comprises one or more links to a repository having the video associated with the plurality of nodes.

6. The NDT device of claim 3, wherein the processor is configured to receive a third user input to send the document to a repository, a device, a system, or a combination thereof.

7. The NDT device of claim 1, wherein the processor is configured to display a reference manual comprising an example of a state of the inspection point corresponding to the displayed node.

8. The NDT device of claim 7, wherein the example comprises an image and a label.

9. The NDT device of claim 1, wherein the NDT device comprises a video borescope, and wherein the display of the node comprises a number of images captured via the video borescope and associated with the node, a number of videos captured via the video borescope and associated with the node, or a combination thereof.

10. A non-transitory tangible computer-readable medium comprising executable code comprising instructions configured to:
navigate a tree model of an inspection, wherein the tree model comprises a plurality of nodes and each of the plurality of nodes corresponds to an inspection point of the inspection;
display each of the plurality of nodes, wherein the display of a node comprises:
an icon indicative of the presence of a flagged image, a flagged video, or a combination thereof associated with the node;
receive a user selection of one of the plurality of nodes;
receive a first user input to acquire an image or video;
associate the image or video with the selected one of the plurality of nodes;
update the display of the selected one of the plurality of nodes; and
generate a document comprising the images associated with the plurality of nodes;
wherein the non-transitory computer-readable medium is part of a non-destructive testing (NDT) device having a processor configured to execute the executable code.

11. The non-transitory computer-readable medium of claim 10, comprising instructions configured to:
display an interactive marker comprising a current path through the tree model, wherein the current path comprises a list of nodes;
receive a second user selection of a node within the interactive marker; and
display the selected node.

12. The non-transitory computer-readable medium of claim 10, wherein the document comprises at least one video associated with the plurality of nodes.

13. The non-transitory computer-readable medium of claim 10, wherein the document further comprises one or more links to a repository having at least one video associated with the plurality of nodes.

14. The non-transitory computer-readable medium of claim 10, further comprising instructions configured to send the document to a repository, a device, a system, or a combination thereof.

15. The non-transitory computer-readable medium of claim 10, further comprising instructions configured to receive a second user selection of a format of the document.

16. The non-transitory computer-readable medium of claim 10, further comprising instructions configured to display a reference manual comprising an example of a state of the inspection point corresponding to the displayed node.

17. The non-transitory computer-readable medium of claim 10, further comprising instructions configured to generate a preview of the document.

18. A method of performing non-destructive testing (NDT), comprising:
navigating a tree model of an inspection, wherein the tree model comprises a plurality of nodes and each of the plurality of nodes corresponds to an inspection point of the inspection;
displaying each of the plurality of nodes, wherein displaying a node comprises:
an icon indicative of the presence of a flagged image, a flagged video, or a combination thereof associated with the node;
receiving a user selection of one of the plurality of nodes;
receiving a user input to acquire an image or video;
associating the image or video with the selected one of the plurality of nodes; and
updating the display of the selected one of the plurality of nodes.

19. The method of claim 18, comprising:
displaying an interactive marker comprising a current path through the tree model, wherein the current path comprises a list of nodes;
receiving a second user selection of a node within the interactive marker; and
displaying the selected node.

20. The method of claim 18, comprising receiving a second user input to generate a document comprising the images associated with the plurality of nodes.
